(19) United States
(12) Patent Application Publication
(10) Pub. No.: US 2015/0226415 A1
(43) Pub. Date: Aug. 13, 2015

(54) LIGHTING DEVICE, DISPLAY DEVICE, AND TELEVISION DEVICE

(71) Applicant: Sharp Kabushiki Kaisha, Osaka-shi, Osaka (JP)

(72) Inventors: Shigenori Tanaka, Osaka-shi (JP); Tetsuyuki Takemoto, Osaka-shi (JP)

(21) Appl. No.: 14/422,465

(22) PCT Filed: Sep. 5, 2013
(86) PCT No.: PCT/JP2013/073932

§ 371 Date: Feb. 19, 2015

(30) Foreign Application Priority Data
Sep. 11, 2012 (JP) 2012-199312

(51) Int. Cl. F21V 23/06; H04N 5/74; F21V 8/00

(52) U.S. Cl. CPC F21V 23/06; G02B 6/0083; G02B 6/0068; G02B 6/009; H04N 5/7441

(57) ABSTRACT

LEDs 32 include anode terminals 34A on one end portions thereof and cathode terminals 34C on another end portions thereof. The LED 32 including the cathode terminal 34C and the adjacent LED 32 including the anode terminal 34A are arranged such that the cathode terminal and the anode terminal 34A are shifted from each other along a plate surface of a flexible board and in a direction perpendicular to an arrangement direction of the LEDs 32. The LEDs 32 further include anode-side wiring patterns 33A connected to the respective anode terminals 34A and cathode-side wiring patterns 33A connected to the respective cathode terminals 34C. The LED 32 including the cathode-side wiring pattern 33C and the adjacent LED 32 including the anode-side wiring pattern 33A are arranged such that the cathode-side wiring pattern 33C and the anode-side wiring pattern 33A partially overlap each other along the plate surface of the flexible board and in the direction perpendicular to the arrangement direction of the LEDs 32.

### TECHNICAL FIELD

The present invention relates to a lighting device, a display device, and a television device.

### BACKGROUND ART

Personal digital assistants such as mobile phones, smartphones, and tablet computers or electronic devices such as computers include display devices including display panels such as liquid crystal panels. Each of the display panels included in such display devices does not emit light itself and therefore, a backlight unit is separately required as a lighting device. The backlight unit is generally classified into either a direct type or an edge-light type according to a mechanism thereof. It is considered that an edge-light type backlight unit is more preferable for further reduction of the thickness of the liquid crystal display device.

The edge-light type backlight unit includes a light guide plate in a casing and the light guide plate has a light entrance surface on at least one edge surface thereof and guides light emitted from a light source such as a light emitting diode (LED) toward a display surface. The light source such as the LED is arranged to be opposite the light entrance surface. Each of the LEDs as the light source is arranged to be adjacent to the light entrance surface and the LEDs are arranged along the light entrance surface. Especially in small personal digital assistants or the electronic devices as described above, the LEDs are mounted on a flexible board that is a flexible LED board. An example of such a backlight unit is described in Patent Document 1.

### RELATED ART DOCUMENT

### Patent Document

Patent Document 1: Japanese Unexamined Patent Application Publication No. 2007-293084

### Problem to be Solved by the Invention

A process of manufacturing such backlight devices includes a step of mounting (with soldering) each of the LEDs on the flexible board. In such a mounting step, each of the LEDs is arranged on the flexible board such that an anode terminal and a cathode terminal of each LED match a corresponding wiring pattern (a land pattern) that is provided on the flexible board as marks. Accordingly, each of the LEDs is positioned in a certain position on the flexible board and then, connection terminals and wiring patterns are connected each other with soldering. As described above, each of the LEDs is required to be positioned precisely on the flexible board in the backlight units included in the small personal digital assistants or the electronic devices. Therefore, each wiring pattern provided on the flexible board as a mark is provided independently in a position where the terminal of each LED is mounted. For example, if an anode terminal of one of two adjacent LEDs is arranged next to a cathode terminal of the other one the adjacent LEDs, an anode-side wiring pattern for positioning the anode terminal of the one LED is arranged away from a cathode-side wiring pattern for positioning the cathode terminal of the other LED. Then, if the adjacent LEDs are connected in series, the anode-side wiring pattern and the cathode-side wiring pattern may be electrically connected to each other with soldering (accordingly, the anode-side wiring pattern and the cathode-side wiring pattern may be electrically connected to each other previously on a surface of the flexible board opposite from a LED mount surface). If the adjacent LEDs are connected in parallel, even after the soldering, the adjacent anode-side wiring pattern and the cathode-side wiring pattern are kept electrically insulated from each other. Namely, in this specification, the anode-side wiring pattern and the cathode-side wiring pattern on the flexible board are provided for positioning each LED on the flexible board precisely and are not related to the electrical connection between the adjacent wiring patterns of the adjacent LEDs.

FIG. 10 is an enlarged plan view illustrating adjacent three LEDs 432 (that are positioned on the flexible board) in the backlight unit of a related art. FIG. 11 is a plan view typically illustrating positional relation between a light guide plate 418 and the LEDs 432 in the vicinity of a light entrance surface 418b of the light guide plate 418. In FIGS. 10 and 11, regarding a display surface side of the backlight unit as a front side, the LEDs 432 are mounted on a rear-side surface of the flexible board. The flexible board is not illustrated in FIG. 10. Therefore, in FIG. 10, anode-side wiring patterns 433A and cathode-side wiring patterns 433C arranged on the flexible board are provided on a most front side (on a front side on a drawing sheet), and anode terminals 434A and cathode terminals 434C of the LEDs 432 are illustrated to be overlapped with the respective wiring patterns 433A, 433C on a rear side (on a rear side on the drawing sheet) of the wiring patterns 433A, 433C. In FIG. 10, a symbol of 432a represents a light emission surface of the LED 432, a symbol of 436 represents an LED package, and a symbol of 438 represents an LED chip. In FIG. 10, a symbol of 418a represents a light exit surface of the light guide plate 418 (a surface facing a front side (a display surface side) of the backlight unit).

As illustrated in FIGS. 10 and 11, in the backlight unit of the related art, the LEDs 432 are mounted on the flexible board along the light entrance surface 418b such that the light emission surfaces 432a face the light entrance surface 418b of the light guide plate 418. The anode terminal 434A is arranged on a front-side surface (a flexible board side surface) of one of two end portions of each LED 432 with respect to the direction in which the LEDs 432 are arranged (the X-axis direction), and the cathode terminal 434C is arranged on the front-side surface of another one of the two end portions. As illustrated in FIG. 10, the anode terminals 434A and the cathode terminals 434C of the LEDs 432 are arranged near an opposite side of the LEDs 432 from the light emission surfaces 432a of the LEDs 432. The anode-side wiring patterns 433A and the cathode-side wiring patterns 433C, which are overlapped with the respective anode terminals 434A and the respective cathode terminals 434C for positioning each of the LEDs 432, are arranged near the opposite side of the LEDs 432 from the light emission surfaces 432a of the LEDs 432. Further, each of the wiring patterns 433A, 433C is greater in a plan view size than each of the terminals 434A, 434C. Each of the wiring patterns 433A, 433C extends from a portion thereof overlapping the terminal 434A (434C) of one LED 432 toward the terminal 434C (434A) of another LED 432 that is adjacent to the one LED 432. Each of the wiring patterns 433A, 433C extends in the direction in which the LEDs 432 are arranged (the X-axis direction). With such a configuration, between the adjacent two LEDs 432, a distal end portion of the wiring pattern 433A (433C), which extends in the X-axis direction from the portion overlapping the terminal 434A (434C) of the one LED 432, faces a distal end portion of the wiring pattern 433C (433A), which extends in the X-axis direction from the portion overlapping the terminal 434C (434A) of the other LED 432, with respect to the direction in which the LEDs 432 are arranged (the X-axis direction) (refer to FIG. 10).

As illustrated in FIGS. 10 and 11, the adjacent two LEDs 432 are required to be away from each other with a distance L2 having at least a certain distance or more so that the facing wiring patterns 433A, 433C are arranged independently from (to be away from) each other. In this specification, a distance between centers of the respective adjacent two LEDs in the LED arrangement direction is defined as a distance between the adjacent LEDs. In FIG. 11, a light distribution of each LED 432 is represented by a dashed-dotted line extending obliquely from each LED 432. Light from each LED 432 does not reach areas that are between the light entrance surface 418b and crossing points of the light distributions of the LEDs 432 and on an outer side than the light distributions of the LEDs 432 and such areas are dark portions. Namely, in FIG. 11, the light from the LEDs 432 does not reach substantially triangle areas defined by the dashed-dotted lines and corresponding to light entrance surface 418b side edge portions of the light guide plate 418 between the adjacent LEDs 432 and such areas are dark portions. An area that is on an outer side (on the light entrance surface 418b side) from a line connecting the crossing points of the light distributions of the LEDs 432 (a dashed-dotted line illustrated along the X-axis direction in FIG. 11) is a non-display area N2 on a light exit surface 418a of the light guide plate 418. A middle area that is on an inner side of the light guide plate 418 from the non-display area N2 is a display area A2 on the light exit surface 418a of the light guide plate 418.

As described before, in the backlight unit of the related art, the distance L2 between the two adjacent LEDs 432 is required to be a certain distance or greater and therefore, the non-display area N2 occupies a large area on the light entrance surface 418b side edge portion of the light guide plate 418. In the small-sized personal digital assistants or electronic devices, the backlight unit is required to be reduced in size. However, the non-display area N2 occupies a large area on the light exit surface 418a of the light guide plate 418 as described before. Therefore, a frame area in the backlight unit is not decreased and the backlight unit is not decreased in size. Reduction in the number of the LEDs 432 decreases the size of the display device, however, the reduction in the number of the LEDs 432 lowers brightness on the light exit surface 418a of the light guide plate 418 and certain brightness is not maintained.

### DISCLOSURE OF THE PRESENT INVENTION

The technology described in this specification was made in view of the above circumstances. An object of the present specification is to decrease a size of a lighting device by decreasing a distance between adjacent light sources with maintaining certain brightness.

### Means for Solving the Problem

The technology described in this specification relates to a lighting device including a light source board, light sources having light-emitting surfaces and mounted on the light source board such that the light-emitting surfaces face a same side, first connection terminals each arranged on each of the light sources and on one of two end portions of each light source with respect to an arrangement direction in which the light sources are arranged, second connection terminals each arranged on each of the light sources and on another one of the two end portions of each light source with respect to the arrangement direction, one of the second connection terminals that is arranged on one of the light sources being arranged to be shifted from one of the first connection terminals that is arranged on another one of the light sources adjacent to the one light source including the one second connection terminal, the one second connection terminal being shifted from the one first connection terminal along a main plate surface of the light source board and in a direction perpendicular to the arrangement direction, first wiring patterns each electrically connected to each of the first connection terminals and extending in the arrangement direction from a portion of the light source where the first connection terminal is arranged; and second wiring patterns each electrically connected to each of the second connection terminals and extending in the arrangement direction from a portion of the light source where the second connection terminal is arranged, one of the second wiring patterns that is connected to the one second connection terminal of the one light source being arranged to be shifted from one of the first wiring patterns that is connected to the one first connection terminal of the other light source that is adjacent to the one light source including the one second connection terminal, the one second wiring pattern partially overlapping the one first wiring pattern along the main plate surface of the light source board and in the direction perpendicular to the arrangement direction.

According to the above lighting device, in mounting the light sources on the light source board, the light sources are arranged such that the connection terminals included in each light source overlap the respective wiring patterns arranged on the light source board. Accordingly, the light sources are positioned on the light source board. The wiring pattern that is connected to the connection terminal of one of the adjacent light sources and the wiring pattern overlap each other along the main plate surface of the light source board and in the direction perpendicular to the arrangement direction of the light sources. With such a configuration, the adjacent light sources are positioned such that the distance therebetween is decreased compared to the configuration in which the wiring patterns do not overlap each other with respect to the above direction. Accordingly, the light sources of the predetermined number are arranged in a smaller area and the light source board is decreased in size with maintaining the certain brightness, and this decreases a size of the lighting device.

The lighting device may further include a light guide plate including one plate surface as a light exit surface and at least one edge surface as a light entrance surface, the light entrance surface is along the arrangement direction of the light sources, and the light guide plate guiding light from the light sources toward the light exit surface.

According to this configuration, the light sources are arranged with the smaller distance therebetween and the light-emitting surfaces of the light sources are opposite the light entrance surface. Therefore, the area of the dark portions that are caused in the portions of the light entrance surface side edge portion of the light guide plate and between the adjacent light sources is decreased. Accordingly, the display area on the light exit surface of the light guide plate is increased and the frame edge portion of the lighting device is decreased in size.

The light sources may be arranged such that the light emitting surfaces are in contact with the light entrance surface.

According to this configuration, the light-emitting surface of each of the light sources is in contact with the light entrance surface so that the light entrance efficiency of light from the light sources and entering the light guide plate through the light entrance surface is improved. Therefore, an area of the dark portions that are caused in the light entrance surface side edge portions of the light guide plate and between the adjacent light sources is further decreased. Accordingly, the display area on the light exit surface of the light guide plate is further increased and the frame edge portion of the lighting device is further decreased in size.

The light source board may be a flexible board having flexibility, and the light sources maybe a side-surface-emitting type.

Generally, such a side-surface-emitting type light source has a mount surface that is mounted on the light source board and that has a smaller area than the light-emitting surface. Therefore, it is difficult to arrange the connection terminals and the wiring patterns so as to decrease the distance between the adjacent light sources. However, with the above configuration, the distance between the adjacent light sources that are side-surface-emitting type light sources is decreased. Therefore, the lighting device is decreased in size with maintaining the certain brightness in a small-sized module including the side-surface-emitting type light sources mounted on the flexible board.

One of the first wiring patterns and the second wiring patterns may be arranged near the light emitting surface of the light source and another one of the first wiring patterns and the second wiring patterns may be arranged near a side opposite from the light emitting surface of the light source.

According to this configuration, the light sources are arranged so that the wiring patterns arranged near the light-emitting surface and the wiring patterns arranged near the side opposite from the light-emitting surface are alternately arranged. This provides a specific arrangement of the wiring patterns that decreases the distance between the adjacent light sources.

Each of the first connection terminals and the second connection terminals may have a L-shape in a plan view of a plate surface of the light source board, and each of the first wiring patterns and the second wiring patterns may have a L-shape in a plan view of the plate surface of the light source board so as to overlap each first connection terminal and each second connection terminals, respectively.

According to this configuration, each of the light sources is mounted on the light source board more stably compared to the configuration in which each of the first connection terminals the second connection terminals has a linear straight shape. Further, a contact area between each of the connection terminals and each of the wiring patterns, respectively, is increased. Therefore, heat dissipates from each of the connection terminals and a heat dissipation property is improved.

The light sources may include one light sources each including both of the first connection terminal and the second connection terminal near the light emitting surface and another light sources each including both of the first connection terminal and the second connection terminal near a side opposite from the light emitting surface, the one light sources and the other light sources being arranged alternately.

According to this configuration, between adjacent light sources, the wiring pattern arranged near the light emitting surface is adjacent to the wiring pattern arranged near the side opposite from the light emitting surface. This provides a specific arrangement of the wiring patterns that decreases the distance between the adjacent light sources. The light sources include two types of light sources including the light sources having the first and second connection terminals near the light emitting surfaces and the light sources having the first and second connection terminals near the side opposite from the light emitting surfaces. For example, one of the two kinds may have high brightness and another one of the two kinds may have good color rendering properties. Further, the two kinds of light sources may have different white chromaticity levels.

One of the one light sources and the other light sources may include the first connection terminals and the second connection terminals both of which have a L-shape in a plan view of a plate surface of the light source board, and the other one of the one light sources and the other light sources may include the first connection terminals and the second connection terminals both of which have a linear shape along the arrangement direction of the light sources in the plan view of the plate surface of the light source board.

According to this configuration, the light sources includes the first and second connection terminals both having a L-shape are included. Therefore, compared to the light sources including the first and second connection terminals both having a linear shape, the light sources are mounted on the light source board more stably. Further, in the light sources including the first and second connection terminals both having a L-shape, a contact area between each of the connection terminals and each of the wiring patterns, respectively, is increased. Therefore, heat dissipates from each of the connection terminals effectively and a heat dissipation property is improved.

The technology described in this specification may be applied to a display device including a display panel displaying using light from the lighting device. The display device including the display panel that is a liquid crystal panel including a pair of substrates and liquid crystals sealed between the substrates may be new and useful. The television device including the display device may be new and useful.

### Advantageous Effect of the Invention

According to the technology described in this specification, the lighting device decreases in size by decreasing the distance between the adjacent light sources with maintaining the certain brightness.

### BRIEF DESCRIPTION OF THE DRAWINGS

FIG. 1 is a schematic cross-sectional view illustrating a cross-sectional configuration along a long-side direction of a liquid crystal device 10 according to a first embodiment.

FIG. 2 is a plan view of a backlight unit 22 seen from a front side.

FIG. 3 is a plan view of a part of a flexible board 30 seen from a rear side.

FIG. 4 is an enlarged plan view of a part of FIG. 3.

FIG. 5 is an enlarged plan view of three adjacent LEDs 32 seen from the front side.

FIG. 6 is a plan view illustrating arrangement of a light guide plate 18 and the LEDs 32 in adjacent to a light entrance surface 18b of the light guide plate 18.

FIG. 7 is an enlarged plan view of three adjacent LEDs 132 seen from the front side according to a second embodiment.

FIG. 8 is an enlarged plan view of three adjacent LEDs 232 seen from the front side according to a third embodiment.

FIG. 9 is an enlarged plan view of three adjacent LEDs 332 seen from the front side according to a fourth embodiment.

FIG. 10 is an enlarged plan view of three adjacent LEDs 432 seen from the front side in a backlight unit of the related art.

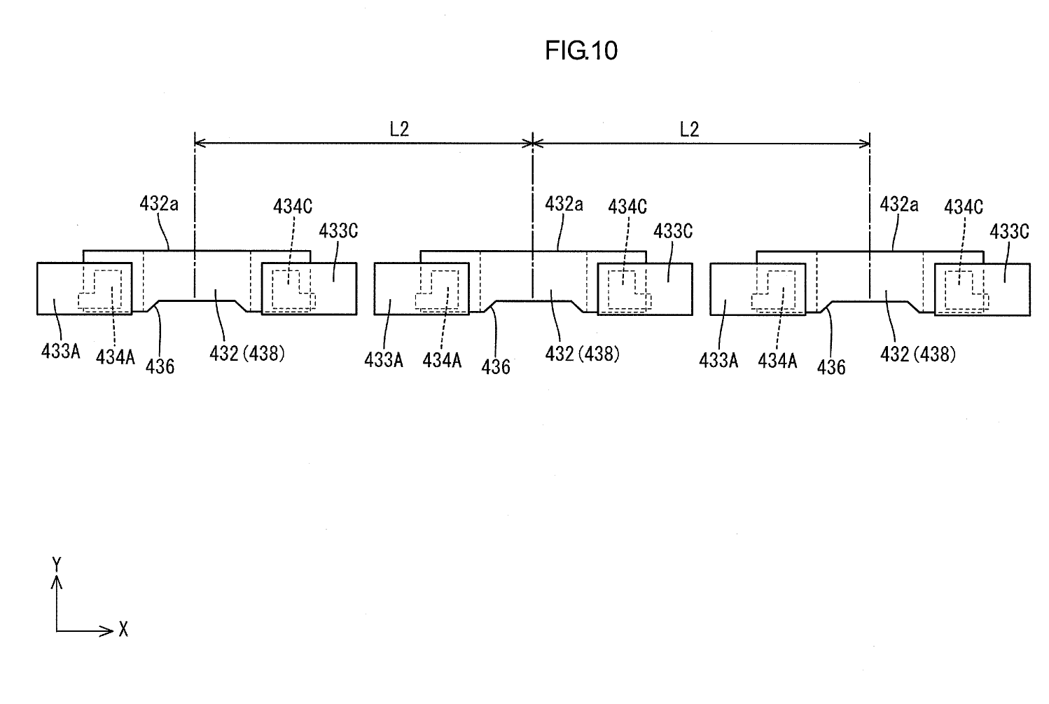

FIG. 11 is a plan view illustrating arrangement of a light guide plate 418 and the LEDs 432 in adjacent to a light entrance surface 418b of the light guide plate 418.

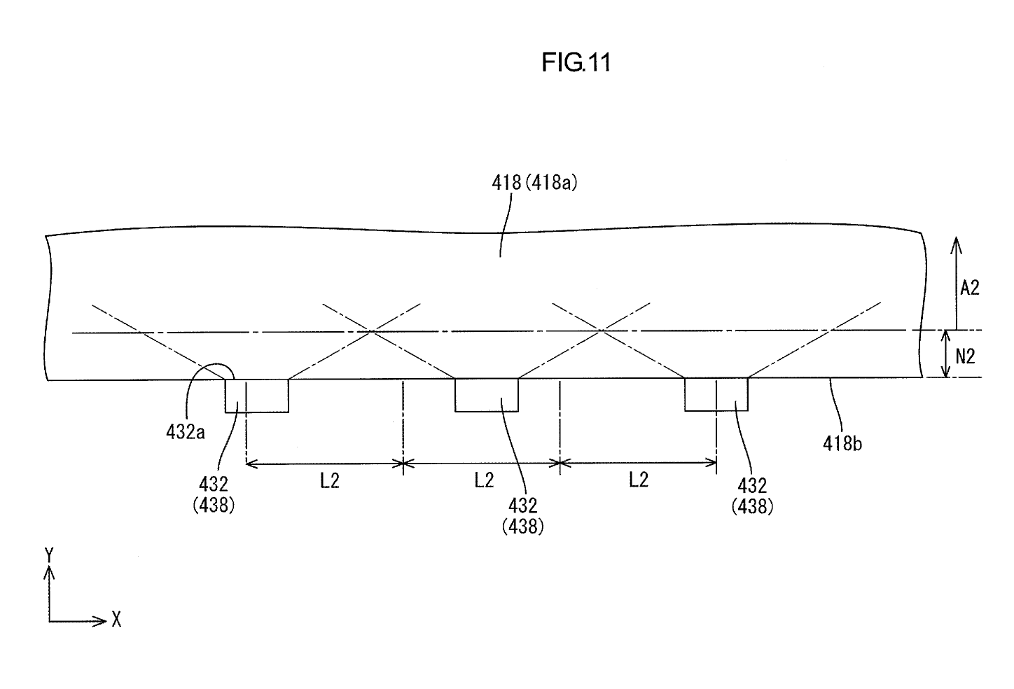

### MODE FOR CARRYING OUT THE INVENTION

### First Embodiment

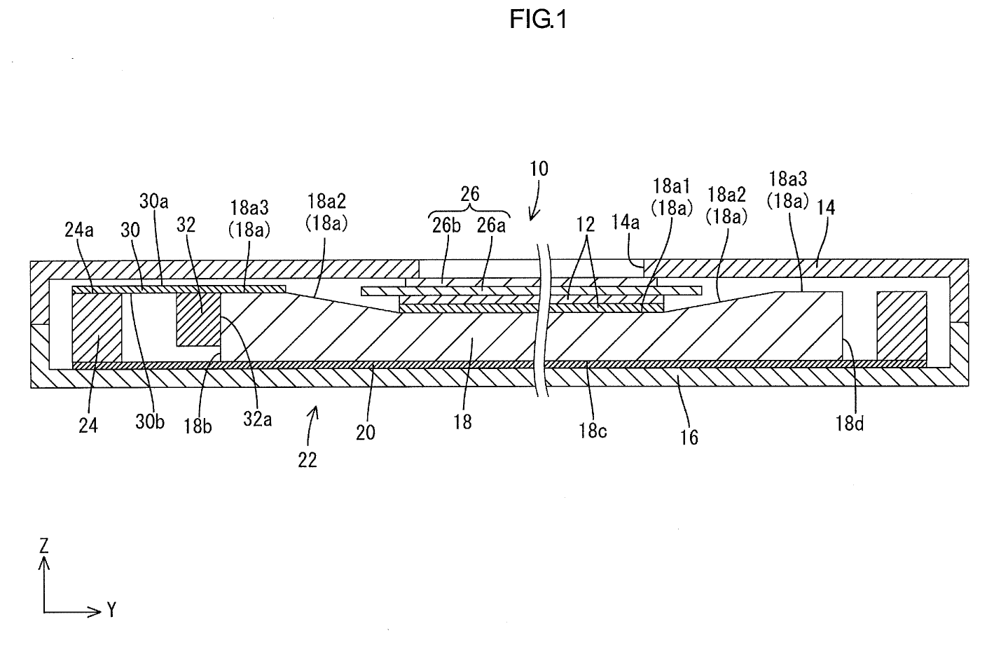

A first embodiment will be described with reference to the drawings. A liquid crystal display device 10 according to this embodiment will be described. The liquid crystal display device 10 according to this embodiment constitutes a television device, which is not illustrated. X-axis, Y-axis and Z-axis are indicated in the drawings. The axes in each drawing correspond to the respective axes in other drawings. The vertical direction in FIG. 1 is defined as a reference. The upper side and the lower side in FIG. 1 correspond to the front side and the rear side, respectively.

As illustrated in FIG. 1, the liquid crystal display device 10 includes a liquid crystal panel (a display panel) 26 including a display portion where images appear, and a backlight unit (a lighting unit) 22 that is an external light source supplying light to the liquid crystal panel 26. The liquid crystal display device 10 further includes a front exterior trim component 14 and a rear exterior trim component 16 for covering and holding the liquid crystal panel 26 and the backlight unit 22 that are mounted together. The exterior trim components 14, 16 are a pair of front and rear components. The front exterior trim component 14 includes a void portion 14a through which the display portion of the liquid crystal panel 26 are viewed from the outside. The liquid crystal display device 10 according to this embodiment is for various electronic devices (not illustrated) including portable information terminals (including electronic book readers and PDAs), mobile phones (including smartphones), notebook computers (including tablet computers), digital photo frames, and portable video game players. The display size of the liquid crystal panel 26 of the liquid crystal display device 10 is from several inches to some dozen inches. Namely, the liquid crystal panel 26 is generally classified as a small sized or a medium sized panel.

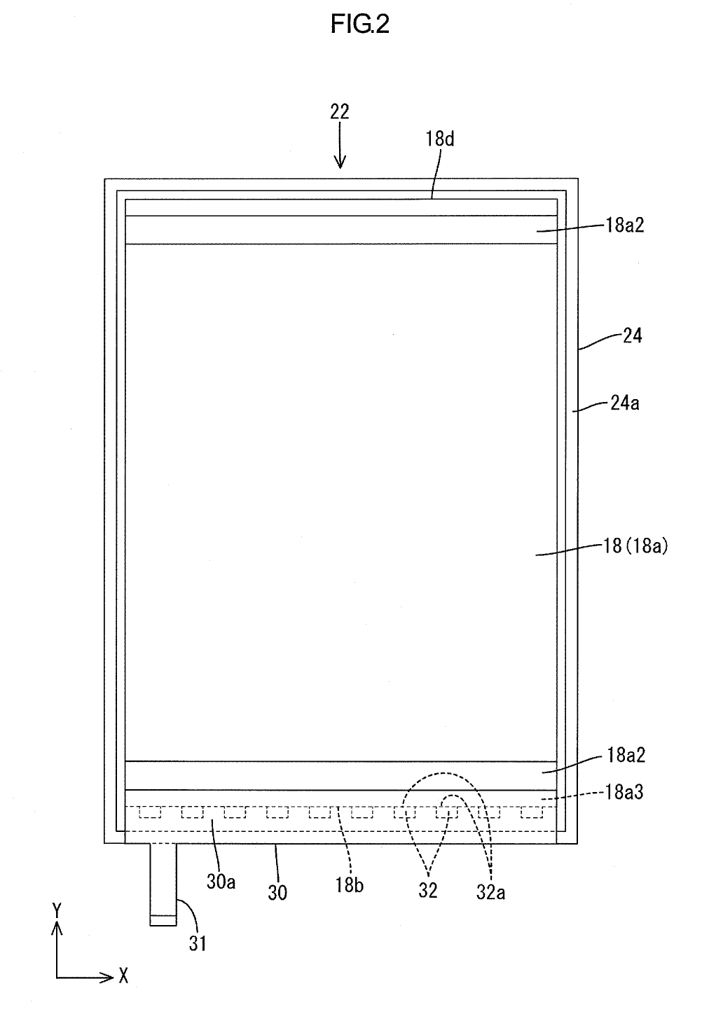

First, the liquid crystal panel 26 will be described. As illustrated in FIG. 1, the liquid crystal panel 26 includes a pair of transparent (with light transmissivity) glass substrates 26a, 26b and a liquid crystal layer (not illustrated) that is between the substrates 26a, 26b. The liquid crystal layer contains liquid crystal molecules, which are substances that change optical characteristics when electromagnetic field is applied. The substrates 26a, 26b are bonded together with a sealant, which is not illustrated, while a gap equal to the thickness of the liquid crystal layer is maintained. One of the substrates 26a, 26b on the rear side (a rear-surface side) is an array board 26a and one on the front side is a CF board 26b. As illustrated in FIGS. 1 and 2, the CF board 26b has a Y-axis direction dimension smaller than that of the array board 26a. On the array substrate 26a, switching elements (e.g. TFTs), pixel electrodes, and an alignment film are arranged. The switching elements are connected to gate lines and source lines that are arranged perpendicular to each other. The pixel electrodes are connected to the switching elements. On the CF substrate 26b, color filters, a counter electrode, and an alignment film are arranged. The color filters include red (R), green (G), and blue (B) color portions that are arranged in a predetermined arrangement. The CF substrate 26b does not overlap a predefined area of the array board 26a and front and back surfaces of the predefined area are exposed to the outside. The mounting section for the driver (not illustrated) and the flexible circuit board (not illustrated) is provided in this area. Accordingly, image data or various control signals necessary for displaying images are supplied to the source lines, the gate lines, and the counter electrode from a drive circuit board, which is not illustrated. Polarizing plates (not illustrated) are attached to outer surfaces of the substrates 26a, 26b, respectively.

Next, the backlight unit 22 will be described. As illustrated in FIGS. 1 and 2, the backlight unit 22 includes a frame 24 made of synthetic resin, a light guide plate 18, LEDs 32, a flexible board 30, an optical sheet set 12, and a reflection sheet 20. The light guide plate 18 has an edge surface that is a light entrance surface 18b. The LEDs 32 are arranged within the frame 24 such that light emission surfaces thereof are opposite the light entrance surface 18b of the light guide plate 18. The flexible board 30 has flexibility and the LEDs 32 are mounted on one surface of the flexible board 30. The optical sheet set 12 is arranged on the front-surface side of the light guide plate 18. The reflection sheet 20 is arranged on the rear-surface side of the light guide plate 18. The optical sheet set 12 is not illustrated in FIG. 2. Hereinafter, each of the components included in the backlight unit 22 will be described.

As illustrated in FIG. 2, similar to the liquid crystal panel 26 and the front exterior trim component 14, the optical sheet set 12 has a landscape rectangular shape in a plan view. The optical sheet set 12 is placed on the front side of the light guide plate 18 (a light exit side), and sandwiched between the liquid crystal panel 26 and the light guide plate 18. Light exiting the light guide plate 18 transmits through the optical sheet set 12 and the light receives predetermined optical effects while passing through the optical sheet set 12 and exits toward the liquid crystal panel 26. The optical sheet set 12 includes multiple sheet-like members which are overlaid with each other. Specifically, the optical sheet set 12 includes a diffuser sheet, a lens sheet, and a reflecting type polarizing sheet, and some or all of the sheets maybe selected to be used. The optical sheet set 12 includes two sheets in FIG. 1.

The light guide plate 18 is made of substantially transparent (high light transmissivity) synthetic resin (e.g. acrylic resin or polycarbonate such as PMMA) which has a refractive index sufficiently higher than that of the air. As illustrated in FIG. 2, the light guide plate 18 has a landscape rectangular shape in a plan view similar to the liquid crystal panel 26. The light guide plate 18 has a plate-like shape having a thickness larger than a thickness of the optical sheet set 12. A short-side direction and a long-side direction of a main surface of the light guide plate 18 correspond to the X-axis direction and the Y-axis direction, respectively. A thickness direction of the light guide plate 18 that is perpendicular to the main surface of the light guide plate 18 corresponds to the Z-axis direction. As illustrated in FIGS. 1 and 2, the light guide plate 18 is arranged just below the liquid crystal panel 26 and the optical sheet set 12 with surrounded by the frame 24. One of the main surfaces of the light guide plate 18 facing the front side (a surface opposite the liquid crystal panel 26 and the optical sheet set 12) is a light exit surface 18a. Light exits the light guide plate 18 through the light exit surface 18a toward the optical sheet set 12 and the liquid crystal panel 26. A surface of the light guide plate 18 opposite from the light exit surface 18a (a rear surface) is an opposite surface 18c. The light guide plate 18 includes peripheral edge surfaces that are adjacent to the main surface of the light guide plate 18. The peripheral edge surfaces include edge surfaces extending along the X-axis direction and one of the edge surfaces (on a left side in FIG. 1 and on lower side in FIG. 2) is opposite the LEDs 32 mounted on the flexible board 30 and is a light entrance surface 18b through which the light from each LED 32 enters the light guide plate 18. The light emitted from each of the LEDs 32 enters the light guide plate 18 through the light entrance surface 18b and the light guide plate 18 is configured to guide the light therein to be directed toward the optical sheet set 12 (the front side, the light exit side) so that the light exits the light guide plate 18 through the main plate surface. Accordingly, the backlight unit 22 according to this embodiment is an edge-light type (a side-light type backlight unit.

As illustrated in FIGS. 1 and 2, the light guide plate 18 includes slope surfaces 18a2 on end portions of the light exit surface 18a with respect to the long-side direction (the Y-axis direction). The slope surfaces 18a2 are sloped gently from the respective end portions of the light guide plate 18 toward a middle (inner) portion of the light guide plate 18. The slope surfaces 18a2 are sloped from the front-surface side toward the rear-surface side and extend in the short-side direction (the X-axis direction). Surfaces that are closer to an edge side of the light guide plate 18 from the slope surfaces 18a2 are edge-side surfaces 18a3, and a surface that is an inner portion of the light guide plate 18 from the slope surfaces 18a2 is a middle surface 18a1. The optical sheet set 12 and the liquid crystal panel 26 are overlaid with each other on the middle surface 18a1 of the light exit surface 18a.

The reflection sheet 20 is arranged to be sandwiched between a main plate surface of the rear exterior trim component 14 and the light guide plate 18 and to be in surface contact with the opposite surface 18c of the light guide plate 18. A short-side dimension of the reflection sheet 20 is larger than that of the light guide plate 16. Ends of the reflection sheet 20 with respect to the long-side direction thereof protrude outwardly than the light entrance surface 18b, that is, closer to the LEDs 32. The light from the LEDs 32 reflects off the extended portions of the reflection sheet 20 and this improves light entrance efficiency of light being incident on the light entrance surface 18b. A scattering portion (not illustrated) that scatters the light travelling within the light guide plate 18 is patterned on the surface of the reflection sheet 20 to have a predetermined in-plane distribution. Accordingly, the light exiting through the light exit surface 18a has an even distribution within a plane.

The flexible board 30 is formed of a film-shaped base member made of a synthetic resin material having insulation and flexibility (for example, polyimide resin) and is arranged near the light entrance surface 18b side end portion of the light guide plate 18. The flexible board 30 is arranged such that the surface 30a thereof is opposite the front exterior trim component 14. The flexible board 30 has a landscape rectangular shape in a plan view and the long-side direction and the short-side direction thereof match the X-axis direction and the Y-axis direction, respectively. One of long-side edge portions of the flexible board 30 overlaps the edge-side surface 18a3 that is on the light entrance surface 18b side. The edge-side surface 18a3 is a part of the light exit surface 18a of the light guide plate 18. The flexible board 30 is fixed to the light guide plate 18 at the overlap portion with adhesive tapes. Another one of the long-side edge portions of the flexible board 30 overlaps the surface 24a of the frame 24 near the light entrance surface 18b and accordingly, the other long-side edge portion of the flexible board 30 is supported by the frame 24.

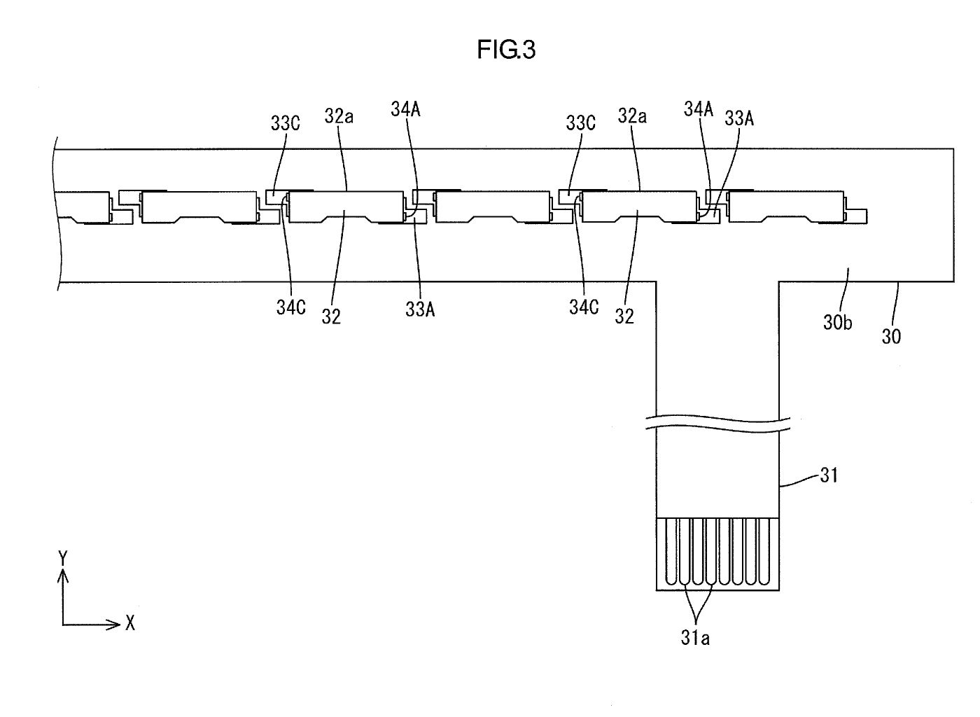

The LEDs 32 are mounted in a middle portion of the rear surface 30b of the flexible board 30 with respect to the short-side direction (the Y-axis direction) of the flexible board 30. The LEDs 32 are arranged in the long-side direction (the X-axis direction) of the flexible board 30. The LEDs 32 are arranged on the rear surface 30b of the flexible board 30 such that the light-emitting surfaces 32a thereof face the light entrance surface 18b of the light guide plate 18 (refer to FIG. 3). The long-side edge of the flexible board 30 that is supported by the frame 24 has an extended portion 31 extending outwardly from a part thereof. The extended portion 31 has a connection terminal 31a at a distal end portion thereof (refer to FIG. 3), and the connection terminal 31a is electrically connected to a supply circuit board (not illustrated) so that the LEDs 32 are supplied with power and driving of each LED 32 is controlled. The extended portion 31 is not illustrated in FIG. 1.

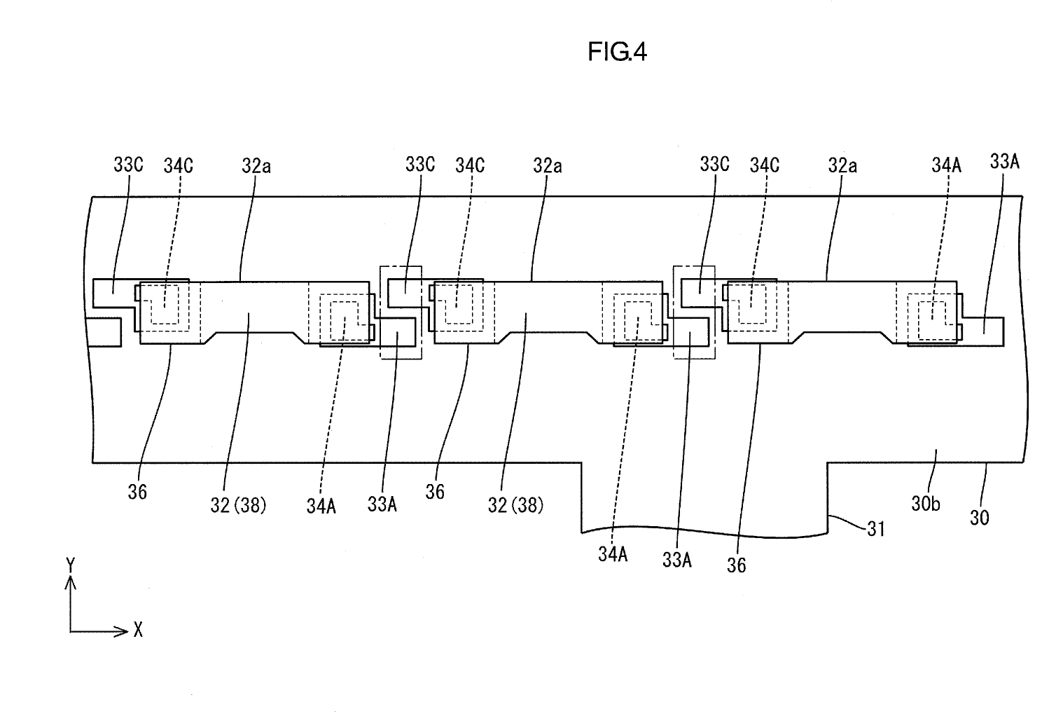

Next, a configuration and arrangement of the LEDs 32 will be described in detail. The LEDs 32 are mounted on the rear surface 30b of the flexible board 30 and each of the LEDs 32 includes an LED chip 38 that is arranged on a board fixed on the LED board 30 and sealed with an LED package 36 made of resin (refer to FIG. 4). The LED chip 38 mounted on the board has one main light emission wavelength. Specifically, the LED chip that emits light in a single color of blue is used. The LED package 36 that seals the LED chip 38 contains phosphors dispersed therein. The phosphors emit light in a predetermined color when excited by blue light emitted from the LED chip 38. Overall color of light emitted from the LED 32 is white. The phosphors may be selected, as appropriate, from yellow phosphors that emit yellow light, green phosphors that emit green light, and red phosphors that emit red light. The phosphors may be used in combination of the above phosphors. The LED 32 includes a mount surface that is mounted on the flexible board 30 and is a front surface (or a rear surface) and a side surface that is the light-emitting surface 32a. Namely, the LED 32 is a side-surface-emitting type LED. The LEDs 32 are arranged on the rear surface 30b of the flexible board 30 linearly (in a line) along the long-side direction (the X-axis direction) at predetermined intervals therebetween. Namely, the LEDs 32 are arranged in one end portion of the backlight unit 22 at intervals along the long-side direction (the X-axis direction) of the flexible board 30.

The LED package 36 that seals the LED chip 38 of each LED 32 has a substantially box shape. The LED package 36 has a flat surface that is on aside close to the light-emitting surface 32a of the LED chip 38 and a recessed surface that is slightly recessed inwardly on a side opposite from the light-emitting surface 32a of the LED chip 38. The LED chip 38 is sealed with the LED package 36 to be positioned in a substantially middle portion of the LED package 36. Further, the light emitting surface 32a of each LED chip 38 is exposed from the LED package 36. As illustrated in FIGS. 1, 2 and 6, the light emitting surface 32a of each LED 32 (LED chip 38) is on the same level as the flat surface of each LED package 36 with respect to the Y-axis direction. The LEDs 32 are arranged along the light entrance surface 18b with the light-emitting surfaces 32a being in contact with the light entrance surface 18b of the light guide plate 18. Namely, the direction in which the LEDs 32 are arranged matches the X-axis direction, and the direction in which the light guide plate 18 and the LEDs 32 are arranged (along the main plate surface direction of the flexible board 30 and perpendicular to the direction in which the LEDs 32 are arranged) matches the Y-axis direction. A distance between each of the LEDs 32 and the light guide plate 18 is zero. In FIGS. 1, 2, and 6, each LED 32 includes only the LED chip 38 as schematically illustrated therein, and the LED package 36 is not illustrated.

A pair of connection terminals (a first connection terminal, a second connection terminal) 34A, 34C is arranged on the mount surface of each LED package 36 that is mounted on the flexible board 30. A part of each connection terminal 34A, 34C is exposed outside the LED package 36. The connection terminals 34A, 34C are electrically connected to the LED chip 38 in each LED package 36. A pair of wiring patterns (a first wiring pattern, a second wiring pattern) 33A, 33C is arranged on portions of the rear surface 30b of the flexible board 30 overlapping the respective connection terminals 34A, 34C included in the LED package 36. The wiring patterns 33A, 33C are greater in size than the connection terminals 34A, 34C, respectively. The connection terminals 34A, 34C included in each LED package 36 are fixed to the respective wiring patterns 33A, 33C provided on the flexible board 30 with soldering (not illustrated) and accordingly, they are electrically connected to each other. Power transmitted from the supply circuit board, which is not illustrated, to the flexible board 30 is supplied to the LEDs 32 via the wiring patterns 33A, 33C and the connection terminals 34A, 34C. The wiring patterns 33A, 33C provided on the flexible board 30 are used as marks for positioning the LEDs 32 on the flexible board 30. The wiring patterns 33A, 33C are arranged on the rear surface 30b of the flexible board 30 independently (away) from each other to position the LEDs 32 on the flexible board 30 precisely.

The connection terminals 34A, 34C included in each LED package 36 are provided on two end portions of the LED package 36 with respect to the arrangement direction of the LEDs 32 (the X-axis direction), respectively. One of the connection terminals is an anode terminal 34A and another one is a cathode terminal 34C. The LEDs 32 are arranged on the flexible board 30 such that the anode terminals 34A and the cathode terminals 34C are arranged alternately along the arrangement direction of the LEDs 32 (the X-axis direction). The LEDs 32 are mounted on the flexible board 30 to be connected in series. In each of the LED packages 36, the anode terminal 34A is arranged closer to a side opposite from the light-emitting surface 32a of the LED 32 and the cathode terminal 34C is arranged closer to the light-emitting surface 32a of the LED 32. Namely, the LEDs 32 are arranged such that the anode terminals 34A and the cathode terminals 34C are arranged in a staggered arrangement (in a zigzag arrangement) such that the cathode terminals 34C are arranged near the light-emitting surface 32a and the anode terminals 34A are arranged near the side opposite from the light-emitting surface 32a of the LED 32. Each of the anode terminals 34A has a substantially plan-view L shape and includes a portion extending in the Y-axis direction and a portion extending from an end of the extended portion that is opposite side from the light-emitting surface 32a of the LED 32 toward outside of the LED package 36 in the X-axis direction. Each of the cathode terminals 34C has a substantially plan-view L shape and includes a portion extending in the Y-axis direction and a portion extending from an end portion of the extended portion that is on the side of the light-emitting surface 32a of the LED 32 toward outside of the LED package 36 (to be away from the LED package 36) in the X-axis direction. As illustrated in FIG. 4, the anode terminals 34A and the cathode terminals 34C include the portions extending in the Y-axis direction that are arranged between the LED packages 36 and the flexible board 30 in a plan view from the rear-surface 20b side of the flexible board 30. Accordingly, the portions extending in the Y-axis direction overlap the LED packages 36 and are not seen from the rear surface 30b side of the flexible board 30 in a plan view. The anode terminals 34A and the cathode terminals 34C further include the portions extending in the X-axis direction that are partially outside the LED packages 36.

The wiring patterns 33A, 33C arranged on the flexible board 30 are an anode-side wiring pattern 33A and a cathode-side wiring pattern 33C. The anode-side wiring pattern 33A overlaps the anode terminal 34A and the cathode-side wiring pattern 33C overlaps the cathode terminal 34C. As illustrated in FIG. 4, the anode-side wiring pattern 33A and the cathode-side wiring pattern 33C have shapes similar to those of the anode terminal 34A and the cathode terminal 34C in a plan view and each of the shapes is a substantially L-shape greater than that of the anode terminal 34A and the cathode terminal 34C. Each anode-side wiring pattern 33A is arranged to overlap a portion of the LED 32 near the side opposite from the light-emitting surface 32a and each cathode-side wiring pattern 33C is arranged to overlap a portion of the LED 32 near the light-emitting surface 32a. Further, each of the anode-side wiring pattern 33A and the cathode-side wiring pattern 33C has an extended portion extending to be away from the LED package 36 in the X-axis direction. A substantially entire area of the extended portion is uncovered by the LED package 36 and seen from the rear surface 30b side of the flexible board 30 in a plan view. The cathode-side wiring pattern 33C has the extended portion extending in the X-axis direction from the portion of one of the adjacent LEDs 32, 32 overlapping the cathode terminal 34C (extending in the arrangement direction of the LEDs 32) and the extended portion has a distal end portion. The anode-side wiring pattern 33A has the extended portion extending in the X-axis direction from the portion of another one of the adjacent LEDs 32, 32 overlapping the anode terminal 34A and the extended portion has a distal end portion. The two distal end portions do not face each other with respect to the arrangement direction of the LEDs (the X-axis direction) in an area surrounded by the dashed-dotted line in FIG. 4 and between the adjacent LEDs 32, 32. The two distal end portions overlap each other in the area along the main plate surface of the flexible board 30 and with respect to a direction perpendicular to the arrangement direction of the LEDs 32, that is, the Y-axis direction.

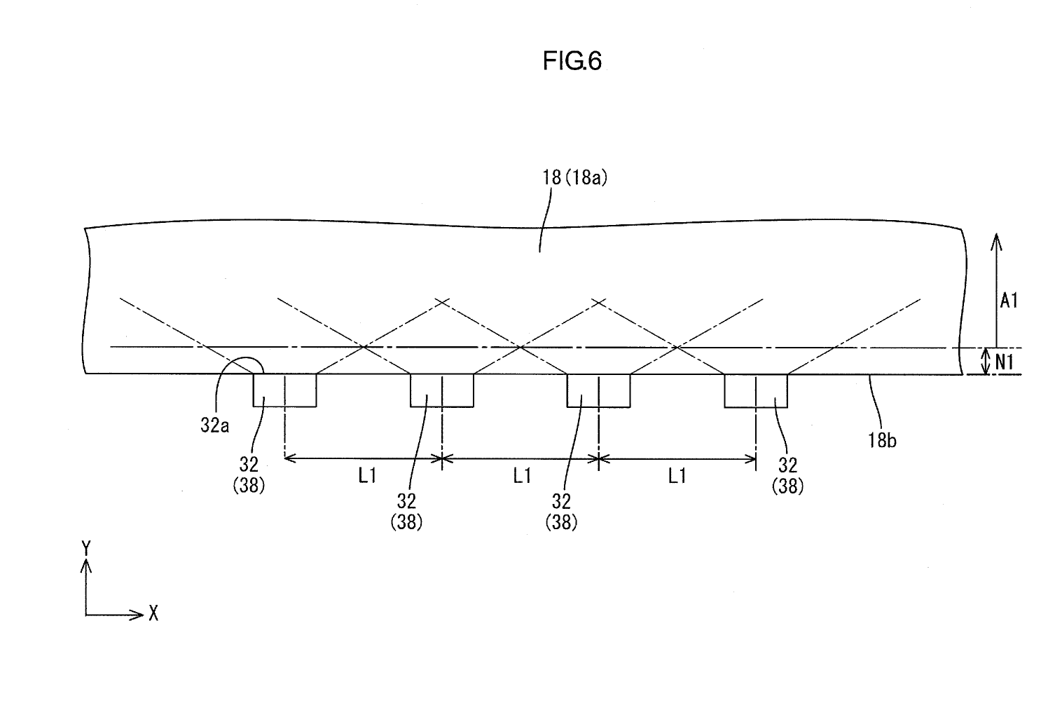

A light distribution of each of the LEDs 32 is represented by the dashed-dotted lines that extend obliquely from each LED 32 in FIG. 6. Light from each LED 32 does not reach areas between the light entrance surface 18b and crossing points of the light distributions of the LEDs 32 and on an outer side from the light distributions of the LEDs 32 and such areas are dark portions. Namely, in FIG. 6, the light from the LEDs 32 does not reach substantially triangle areas defined by the dashed-dotted lines and corresponding to portions of a light entrance surface 18b side edge portions of the light guide plate 18 between the adjacent LEDs 32 and such areas are dark portions. An area N1 that is on an outer side (on the light entrance surface 18b side) from aline connecting the crossing points of the light distributions of the LEDs 32 (a dashed-dotted line illustrated along the X-axis direction in FIG. 6) is a non-display area N1 on the light exit surface 18a of the light guide plate 18. An area A1 that is in a middle portion (on an inner side) of the light guide plate 18 from the non-display area N1 is a display area A1 on the light exit surface 18a of the light guide plate 18. According to the present embodiment, a part of each anode-side wiring pattern 33A and a part of each corresponding cathode-side wiring pattern 33C overlap each other with respect to the Y-axis direction between the adjacent LEDs 32, 32. Accordingly, with the configuration in which the wiring patterns 33A, 33C are provided independently (away) from each other, the distance L1 between the adjacent LEDs 32 becomes smaller than the distance L2 between the adjacent LEDs 432 in the backlight unit of the related art. Specifically, according to the present embodiment, the distance L1 between the adjacent LEDs 32 is decreased by approximately 12% than the distance L2 between the adjacent LEDs 432 of the backlight unit of the related art. Therefore, the dark portions caused on the light exit surface 18a of the light guide plate 18 have areas smaller than those caused in the related art. The non-display area N1 on the light exit surface 18a of the light guide plate 18 becomes smaller than the non-display area N2 on the light exit surface 418a of the light guide plate 418 in the backlight unit of the related art. Accordingly, in the backlight unit 22 of the present embodiment, the light exit surface 18a of the light guide plate 18 has the display area A1 greater than the display area A2 on the light exit surface 418a of the light guide plate 418. Namely, the display area A1 is increased toward the light entrance surface 18b side. As a result, the backlight unit 22 further decreases a size of the frame edge portion compared to the backlight unit of the related art.

Next, steps of mounting the LEDs 32 on the flexible board 30 (with soldering) in a process of manufacturing the backlight unit 22 according to the present embodiment will be described. First, the anode terminal 34A and the cathode terminal 34C of each LED 32 is positioned to be overlapped with the anode-side wiring pattern 33A and the cathode-side wiring pattern 33C, respectively, which are previously arranged on the flexible board as the marks. Thus, the LEDs 32 are arranged on the flexible board 30. In the arrangement of the LEDs 32, the LEDs 32 are arranged such that the flat light emitting-surfaces 32a of the LEDs 32 (the LED packages 36) are in contact with the light entrance surface 18b of the light guide plate 18. Accordingly, the light-emitting surfaces 32a of the LEDs 32 are parallel to the light entrance surface 18b of the light guide plate 18 and the LEDs 32 are arranged on the flexible board 30 along the light entrance surface 18b (in the X-axis direction). Next, the connection terminals 34A, 34C are fixed to the corresponding wiring patterns 33A, 33C, respectively, with soldering. In the present embodiment, the LEDs 32 that are arranged linearly on the flexible board 30 are connected in series. Therefore, after the LEDs 32 are arranged and positioned on the flexible board 30, the cathode terminal 34C (the cathode-side wiring pattern 33C) and the anode terminal 34A (the anode-side wiring pattern 33A) that are adjacent to each other may be electrically connected with soldering that is provided therebetween. However, this may not cause any problems. According to the above steps, the LEDs 32 are arranged linearly and mounted with positioned precisely on the rear surface 30b of the flexible board 30.

As described before, in the backlight unit 22 according to the present embodiment, in mounting the LEDs 32 on the flexible board 30, the LEDs 32 are arranged such that the connection terminals 34A, 34C included in each LED 32 overlap the respective wiring patterns 33A, 33C arranged on the flexible board 30. Accordingly, the LEDs 32 are positioned on the flexible board 30. The anode-side wiring pattern 33A (the cathode-side wiring pattern 33C) is connected to the anode terminal 34A (the cathode terminal 34C) of one of the adjacent LEDs 32. The cathode-side wiring pattern 33C (the anode-side wiring pattern 33A) is connected to the cathode terminal 34C (the anode terminal 34A) of another one of the adjacent LEDs 32. The anode-side wiring pattern 33A (the cathode-side wiring pattern 33C) connected to the one of the LEDs 32 overlaps the cathode-side wiring pattern 33C (the anode-side wiring pattern 33A) connected to the other one of the LEDs 32 along the main plate surface of the flexible board 30 and in the direction perpendicular to the arrangement direction of the LEDs 32, that is, the Y-axis direction. With such a configuration, the adjacent LEDs 32 are positioned such that the distance L1 therebetween is decreased compared to the configuration of the backlight unit of the related art including the wiring patterns 33A, 33C that do not overlap with each other with respect to the above direction. Accordingly, the LEDs 32 of the predetermined number are arranged in a smaller area and the flexible board 30 is decreased in size with maintaining the certain brightness, and this decreases a size of the backlight unit 22.

The backlight unit 22 according to the present embodiment further includes the light guide plate 18 having one main plate surface as the light exit surface 18a and one edge surface as the light entrance surface 18b. The light entrance surface 18b is parallel to the arrangement direction of the LEDs 32 (the X-axis direction) and the light guide plate 18 guides light from the LEDs 32 toward the light exit surface 18a. According to such a configuration, the LEDs 32 are arranged with the smaller distance L1 therebetween and the light-emitting surfaces 32a of the LEDs 32 are opposite the light entrance surface 18b. Therefore, the area of the dark portions that are caused in the portions of the light entrance surface 18b side edge portion of the light guide plate 18 and between the adjacent LEDs 32 is decreased. Accordingly, the display area A1 on the light exit surface 18a of the light guide plate 18 is increased toward the light entrance surface 18b and the frame edge portion of the backlight unit 22 is decreased in size.

In the backlight unit 22 according to the present embodiment, the LEDs 32 are arranged such that the light-emitting surface 32a of each of the LEDs 32 is in contact with the light entrance surface 18b. According to such a configuration in which the light-emitting surface of each of the LEDs 32 is in contact with the light entrance surface 18b, the light entrance efficiency of light from the LEDs 32 and entering the light guide plate 18 through the light entrance surface 18b is improved. Therefore, an area of the dark portions that are caused in the light entrance surface 18b side edge portions of the light guide plate 18 and between the adjacent LEDs 32 is further decreased. Accordingly, the display area A1 on the light exit surface 18a of the light guide plate 18 is further increased and the frame edge portion of the backlight unit 22 is further decreased in size.

In the backlight unit 22 according to the present embodiment, the board where the LEDs 32 are mounted is the flexible board 30 having flexibility. Further, each of the LEDs 32 is a side-surface-emitting type LED 32. Generally, such a side-surface-emitting type LED 32 has a mount surface that is mounted on the flexible board 30 and that has a smaller area than the light-emitting surface 32a. Therefore, it is difficult to arrange the connection terminals and the wiring patterns so as to decrease the distance between the adjacent LEDs. However, with the configuration according to the present embodiment, the distance L1 between the adjacent LEDs 32 that are side-surface-emitting type LEDs is decreased. Therefore, the backlight unit 22 is decreased in size with maintaining the certain brightness in a small-sized module including the side-surface-emitting type LEDs 32 mounted on the flexible board 30.

In the backlight unit 22 according to the present embodiment, the anode-side wiring patterns 33A and the cathode-side wiring patterns 33C are arranged on the flexible board 30 such that the cathode-side wiring patterns 33C are arranged near the light-emitting surface 32a and the anode-side wiring patterns 33A are arranged near the side opposite from the light-emitting surface 32a of the LED 32. With such a configuration, the LEDs 32 are arranged so that the cathode-side wiring patterns 33C arranged near the light-emitting surface 32a and the anode-side wiring patterns 33A arranged near the side opposite from the light-emitting surface 32a are alternately arranged. This provides a specific arrangement of the wiring patterns 33A, 33C that decreases the distance L1 between the adjacent LEDs 32.

In the backlight unit 22 according to the present embodiment, each of the anode terminals 34A and the cathode terminals 34C has a substantially L-shape in a plan view of the main plate surface of the flexible board 30. Further, each of the anode-side wiring patterns 33A and cathode-side wiring patterns 33C has a substantially L-shape in a plan view of the main plate of the flexible board 30 so as to overlap the anode terminal 34A and the cathode-terminal 34C, respectively. With such a configuration, each of the LEDs 32 is mounted on the flexible board 30 more stably compared to the configuration in which each of the anode terminals 34A and the cathode terminals 34C has a linear straight shape. Further, with the above configuration, a contact area between each of the connection terminals 34A, 34C and each of the wiring patterns 33A, 33C, respectively, is increased. Therefore, heat generated from the LEDs 32 when the LEDs 32 are lighted dissipates toward the flexible board 30 via the connection terminals 34A, 34B effectively, and a heat dissipation property is improved.

### Second Embodiment

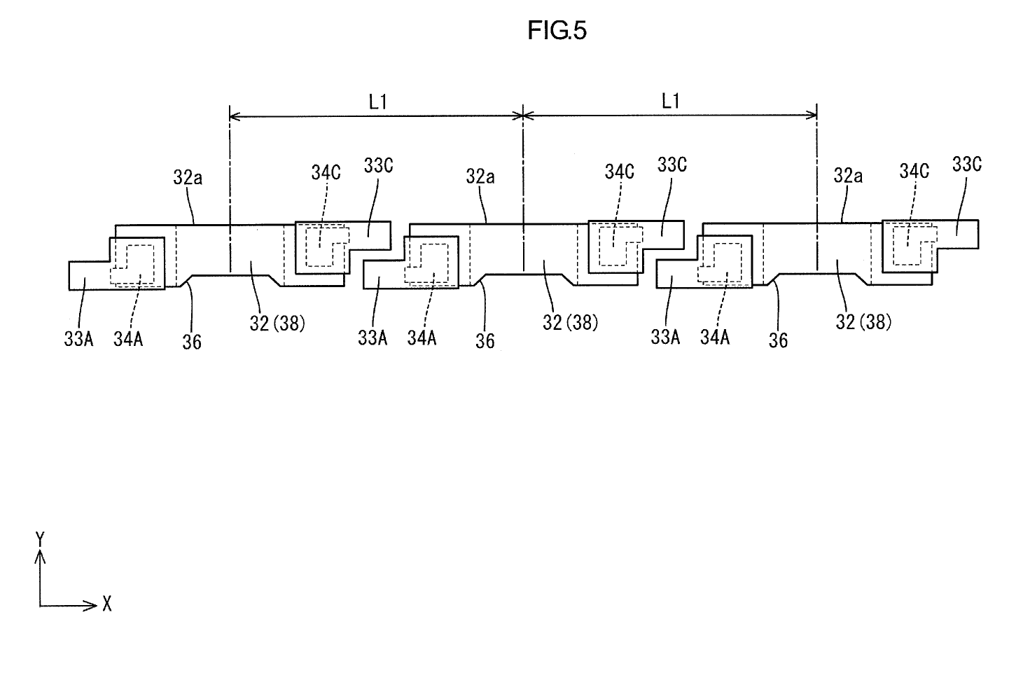

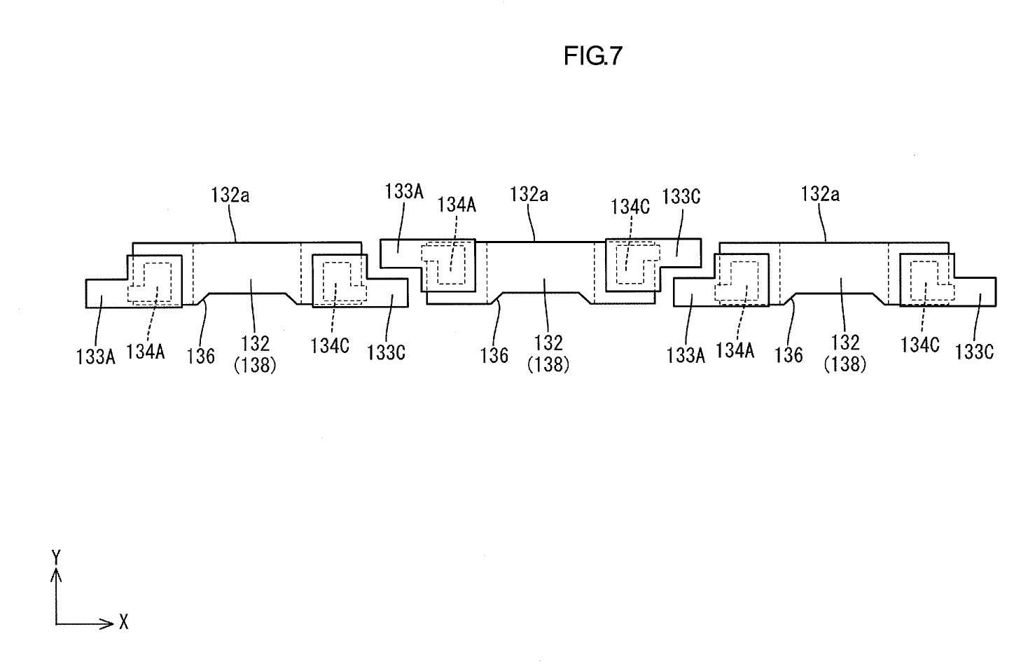

A second embodiment will be described with reference to the drawing. According to the second embodiment, an arrangement of connection terminals 134A, 134C and wiring patterns 133A, 133C differs from that of the first embodiment. Other configurations are similar to those of the first embodiment and configurations, operations, and effects of the second embodiment will not be described. In FIG. 7, components provided with reference numbers obtained by adding 100 to the reference numbers in FIG. 5 are same as those in the first embodiment.

As illustrated in FIG. 7, a backlight unit according to the second embodiment includes LEDs 132 each including an anode terminal 134A and a cathode terminal 134C both of which are arranged near a light-emitting surface 132a of the LED 132 and LEDs 132 each including the anode terminal 134A and the cathode terminal 134C both of which are arranged near the side opposite from the light-emitting surface 132a of the LED 132. Such two types of LEDs 132 are arranged alternately on the flexible board according to the present embodiment. Anode-side wiring patterns 133A and cathode-side wiring patterns 133C are arranged on the flexible board so as to overlap the anode terminals 134A and the cathode terminals 134C of the arranged LEDs, respectively. The connection terminals 134A, 134C and the wiring patterns 133A, 133C have shapes similar to those of the first embodiment.

According to the present embodiment, the two kinds of LEDs 132 are used. Therefore, one of the two kinds of LEDs 132 may have high brightness and another one of the two kinds of LEDs 132 may have good color rendering properties. Accordingly, the backlight unit may have both of high brightness and good color rendering properties. Further, for example, the color rendering properties of light exiting the light guide plate through the light exit surface may be controlled by differentiating the two kinds of LEDs 132 in a white chromaticity level. The anode terminals 134A and the cathode terminals 134C are arranged differently in each of the two types of the LEDs 132. Therefore, the two types of the LEDs 132 are easily distinguished from each other and they are less likely to be mounted on the flexible board in a wrong arrangement.

According to the present embodiment, the two types of LEDs 132 having the above configurations are arranged alternately and the wiring patterns 133A, 133C are arranged to overlap the connection terminals 134A, 134C, respectively. The anode-side wiring pattern 133A (the cathode-side wiring pattern 133C) is connected to the anode terminal 134A (the cathode terminal 134C) of one of the adjacent LEDs 132. The cathode-side wiring pattern 133C (the anode-side wiring pattern 133A) is connected to the cathode terminal 134C (the anode terminal 134A) of another one of the LEDs 132. Similar to the first embodiment, the anode-side wiring pattern 133A (the cathode-side wiring pattern 33C) connected to the one of the LEDs 132 overlaps the cathode-side wiring pattern 33C (the anode-side wiring pattern 33A) connected to the other one of the LEDs 132 along the main plate surface of the flexible board 30 and in a direction perpendicular to the arrangement direction of the LEDs 32, that is, the Y-axis direction. With such a configuration, the distance between the adjacent LEDs 132 is decreased compared to the backlight unit of the related art and the backlight unit is further decreased in size and has a decreased area of a frame edge portion.

### Third Embodiment

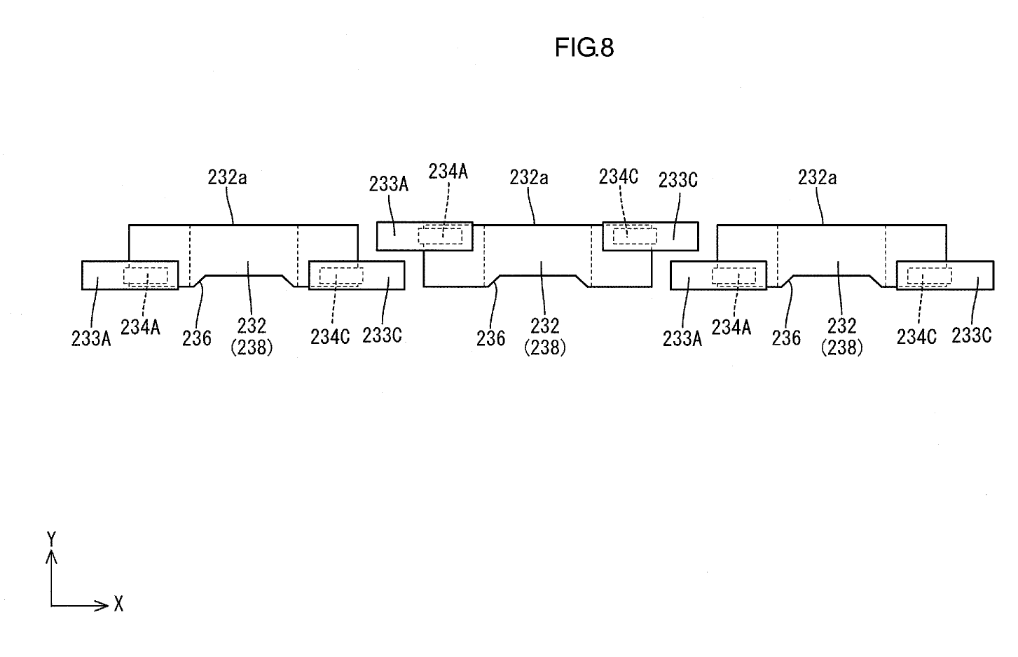

A third embodiment will be described with reference to the drawing. According to the third embodiment, shapes of connection terminals 234A, 234C and wiring patterns 233A, 233C differ from those of the first embodiment. Other configurations are similar to those of the first embodiment and configurations, operations, and effects of the third embodiment will not be described. In FIG. 8, components provided with reference numbers obtained by adding 200 to the reference numbers in FIG. 5 are same as those in the first embodiment.

As illustrated in FIG. 8, in a backlight unit according to the third embodiment, an anode terminal 234A and a cathode terminal 234C arranged on each of LEDs 232 have a linear shape extending in the arrangement direction of the LEDs 232. The anode terminals 234A and the cathode terminals 234C are arranged similarly to the second embodiment. Namely, in the present embodiment, two types of the LEDs 232 includes the LEDs 232 including the anode terminals 234A and the cathode terminals 234C both of which are arranged near light-emitting surfaces 232a of the LEDs 232 and the LEDs 232 including the anode terminals 234A and the cathode terminals 234C both of which are arranged near the side opposite from the light-emitting surfaces 232a of the LEDs 232. Such LEDs of the two types are alternately arranged on the flexible board. The anode-side wiring patterns 233A and the cathode-side wiring patterns 233C have shapes similar to the connection terminals 234A, 234C and are arranged on the flexible board to overlap the anode terminals 234A and the cathode terminals 234C, respectively. With such a configuration, the anode-side wiring pattern 233A and the cathode-side wiring pattern 233C overlap each other between the adjacent LEDs 232 along a main plate surface of the flexible board and with respect to a direction perpendicular to the arrangement direction of the LEDs 232. Accordingly, the distance between the adjacent LEDs 232 is decreased compared to the backlight unit of the related art and the backlight unit is further decreased in size and has a decreased area of a frame edge portion. Further, according to the present embodiment, with the above configuration, the LEDs 232 of two types are used and the effects thereof are similar to those in the second embodiment and will not be described.

### Fourth Embodiment

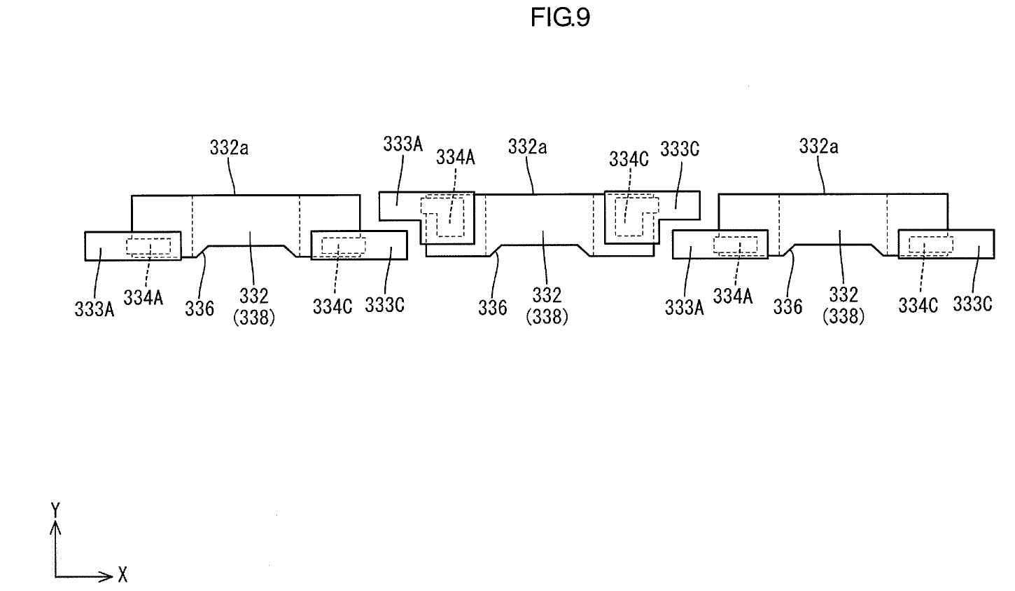

A fourth embodiment will be described with reference to the drawing. The fourth embodiment includes the configuration of the second embodiment and the configuration of the third embodiment, in combination. Other configurations are similar to those of the first embodiment and configurations, operations, and effects of the fourth embodiment will not be described. In FIG. 9, components provided with reference numbers obtained by adding 300 to the reference numbers in FIG. 5 are same as those in the first embodiment.

As illustrated in FIG. 9, a backlight unit according to the fourth embodiment includes LEDs 332 each including an anode terminal 334A and a cathode terminal 334C both of which are arranged near a light-emitting surface 332a of the LED 332 and have a substantially L-shape in a plan view and LEDs 332 each including the anode terminal 334A and the cathode terminal 334C both of which are arranged near the opposite side from the light-emitting surface 332A of the LED 332 and have a straight linear shape along the X-axis direction in a plan view. Such two types of LEDs 332 are arranged alternately on the flexible board. Anode-side wiring patterns 333A and cathode-side wiring patterns 333C are arranged similarly to the connection terminals 334A, 334C and have similar shapes as the respective connection terminals 334A, 334C. According to such a configuration, the anode-side wiring pattern 333A and the cathode-side wiring pattern 333C overlap each other between the adjacent LEDs 332 along a main plate surface of the flexible board and in a direction perpendicular to the arrangement direction of the LEDs 332. With such a configuration, the distance between the adjacent LEDs 332 is decreased compared to the backlight unit of the related art and the backlight unit is further decreased in size and has a decreased area of a frame edge portion. Further, according to the present embodiment, with the above configuration, the LEDs 332 of two types are used and the effects thereof are similar to those in the second embodiment and will not be described.

Modifications of each of the above embodiments will be described below.

(1) In each of the above embodiments, the shape of each of the connection terminals mounted on the LED is similar to that of corresponding one of the connection wiring arranged on the flexible board. However, the connection terminal may have a shape different from the corresponding connection wiring that overlaps the connection terminal.

(2) In each of the above embodiments, the LEDs are side-surface-emitting type LEDs. However, each of the LEDs may be a top-surface-emitting type LED that has a light-emitting surface on an opposite side from a mount surface that is mounted on the LED board.

(3) In each of the above embodiments, the backlight unit is an edge-light type backlight unit. However, the backlight unit may be a direct-type backlight unit including top-surface-emitting type LEDs and light-emitting surfaces of the LEDs may face a liquid crystal panel.

(4) In each of the above embodiments, the LEDs are arranged to be connected in series. However, the LEDs may be arranged to be connected in parallel. In such a configuration, a wiring pattern that is connected to one of adjacent LEDs is not electrically connected to a wiring pattern that is connected to another one of the adjacent LEDs with decreasing the distance between the adjacent LEDs.

(5) In each of the above embodiments, various arrangements of the connection terminals and the wiring patterns on the LEDs that are mounted on a small-sized backlight unit are described. However, the configurations of the above embodiments may be applied to a large-sized backlight unit. In such a configuration, the board where the LEDs are mounted may be a LED board having no flexibility.

(6) Other than the above embodiments, a shape of each connection terminal and an arrangement of the connection terminals and a shape of each wiring pattern and an arrangement of the wiring patterns may be altered if necessary.

(7) In each of the above embodiments, the liquid crystal display device including the liquid crystal panel as a display panel is provided as an example. However, a display device including other kind of display panel is included in the scope of the present invention.

(8) In each of the above embodiments, the television device includes a tuner. However, a television device including no tuner is included in the scope of the present invention.

The embodiments of the present invention are described in detail. However, the present invention is not limited to the embodiments described above. Technology described in the claims includes various modifications and changes of the above embodiments.

The technical elements described in the specification or drawings exhibit the technical usefulness individually or in various combination thereof and are not limited to the combination in claims as filed. Furthermore, the technologies illustrated in the specification or drawings realize a plurality of purposes at the same time and have a technical usefulness when one of the purposes is realized.

### EXPLANATION OF SYMBOLS

10: liquid crystal display device, 12: optical sheet, 14: front exterior trim component, 16: rear exterior trim component, 18: light guide plate, 18a: light exit surface, 18b: light entrance surface, 18c: opposing surface, 20: reflection sheet, 22: backlight unit, 24: frame, 26: liquid crystal panel, 30: flexible board, 30a: front surface (of the flexible board), 30b: rear surface (of the flexible board), 31: extended portion, 32, 132, 232, 332, 432: LED, 32a, 132a, 232a, 332a, 432a: light-emitting surface, 33A, 133A, 233A, 333A, 433A: anode-side wiring pattern, 33C, 133C, 233C, 333C, 433C: cathode-side wiring pattern, 34A, 134A, 234A, 334A, 434A: anode terminal, 34C, 134C, 234C, 334C, 434C: cathode terminal, 36, 136, 236, 336: LED package, 38, 138, 238, 338, 438: LED chip

1. A lighting device comprising:
a light source board;
light sources having light-emitting surfaces and mounted on the light source board such that the light-emitting surfaces face a same side;
first connection terminals each arranged on each of the light sources and on one of two end portions of each light source with respect to an arrangement direction in which the light sources are arranged;
second connection terminals each arranged on each of the light sources and on another one of the two end portions of each light source with respect to the arrangement direction, one of the second connection terminals that is arranged on one of the light sources being arranged to be shifted from one of the first connection terminals that is arranged on another one of the light sources adjacent to the one light source including the one second connection terminal, the one second connection terminal being shifted from the one first connection terminal along a main plate surface of the light source board and in a direction perpendicular to the arrangement direction;
first wiring patterns each electrically connected to each of the first connection terminals and extending in the arrangement direction from a portion of the light source where the first connection terminal is arranged; and
second wiring patterns each electrically connected to each of the second connection terminals and extending in the arrangement direction from a portion of the light source where the second connection terminal is arranged, one of the second wiring patterns that is connected to the one second connection terminal of the one light source being arranged to be shifted from one of the first wiring patterns that is connected to the one first connection terminal of the other light source that is adjacent to the one light source including the one second connection terminal, the one second wiring pattern partially overlapping the one first wiring pattern along the main plate surface of the light source board and in the direction perpendicular to the arrangement direction.

2. The lighting device according to claim 1, further comprising a light guide plate including one plate surface as a light exit surface and at least one edge surface as a light entrance surface, the light entrance surface is along the arrangement direction of the light sources, and the light guide plate guiding light from the light sources toward the light exit surface.

3. The lighting device according to claim 2, wherein the light sources are arranged such that the light emitting surfaces are in contact with the light entrance surface.

4. The lighting device according to claim 2, wherein
the light source board is a flexible board having flexibility, and
the light sources are a side-surface-emitting type.

5. The lighting device according to claim 1, wherein
the light sources are arranged such that the first connection terminals and the second connection terminals are arranged alternatively, and the first connection terminals are arranged one of near the light emitting surface of the light source and near a side opposite from the light emitting surface of the light source, and the second connection terminals are arranged another one of near the light emitting surface of the light source and near a side opposite from the light emitting surface of the light source.

6. The lighting device according to claim 1, wherein the first wiring patterns are arranged one of near the light emitting surface of the light source and near a side opposite from the light emitting surface of the light source, and the second wiring patterns are arranged another one of near the light emitting surface of the light source and near the side opposite from the light emitting surface of the light source.

7. The lighting device according to claim 6, wherein
each of the first connection terminals and the second connection terminals has a L-shape in a plan view of a plate surface of the light source board, and
each of the first wiring patterns and the second wiring patterns has a L-shape in a plan view of the plate surface of the light source board so as to overlap each first connection terminal and each second connection terminals, respectively.

8. The lighting device according to claim 1, wherein the light sources include one light sources each including both of the first connection terminal and the second connection terminal near the light emitting surface and another light sources each including both of the first connection terminal and the second connection terminal near a side opposite from the light emitting surface, the one light sources and the other light sources being arranged alternately.

9. The lighting device according to claim 8, wherein
one of the one light sources and the other light sources include the first connection terminals and the second connection terminals both of which have a L-shape in a plan view of a plate surface of the light source board, and
the other one of the one light sources and the other light sources include the first connection terminals and the second connection terminals both of which have a linear shape along the arrangement direction of the light sources in the plan view of the plate surface of the light source board.

10. A display device comprising:
the lighting device according to claim 1; and
a display panel displaying using light from the lighting device.

11. The display device according to claim 10, wherein the display panel is a liquid crystal panel including a pair of substrates and liquid crystals sealed between the substrates.

12. A television device comprising the display device according to claim 10.
